(19) United States
(12) Patent Application Publication
(10) Pub. No.: US 2024/0424774 A1
(43) Pub. Date: Dec. 26, 2024

(54) TUBE LAMINATE WITH EXACTLY ONE PREFABRICATED FILM AND POLYMER LAYERS APPLIED ON BOTH SIDES

(71) Applicant: Huhtamaki Flexible Packaging Germany GmbH & Co. KG, Ronsberg (DE)

(72) Inventors: Mayara Souza, Parnamirim - RN (BR); Wolfgang Losert, Obergünzburg (DE); Rebekka Jägerhuber, Markt Rettenbach (DE); Benjamin Spöttle, Sulzberg (DE)

(21) Appl. No.: 18/746,107

(22) Filed: Jun. 18, 2024

(30) Foreign Application Priority Data
Jun. 23, 2023 (DE) 10 2023 116 656.5
Jun. 30, 2023 (DE) 10 2023 117 415.0

(51) Int. Cl. B32B 27/08; B32B 1/08; B32B 7/027; B32B 27/32; B65D 35/08

(52) U.S. Cl. CPC B32B 27/08; B32B 1/08; B32B 7/027; B32B 27/32; B65D 35/08; B32B 2250/242; B32B 2307/30; B32B 2307/31; B32B 2307/7376; B32B 2307/75; B32B 2439/40; B32B 2597/00

(57) ABSTRACT

A tube laminate having at least three polymer layer arrangements each with at least one polymer layer, where exactly one polymer layer arrangement as a carrier structure is a prefabricated film, where a first side of the prefabricated film carries an outer polymer layer arrangement forming an outside of the tube laminate and where a second side of the prefabricated film which is opposite to the first side carries an inner polymer layer arrangement forming an inside of the tube laminate, where the outer and the inner polymer layer arrangement are polymer layer arrangements applied in the flowable state, where the tube laminate does not exhibit a further prefabricated film other than the carrier structure.

This application claims priority in German Patent Applications DE 10 2023 116 656.5 filed on Jun. 23, 2023 and DE 10 2023 117 415.0 filed on Jun. 30, 2023, which are both incorporated by reference herein.

The present invention concerns a tube laminate for the manufacturing of tube containers. The tube laminate comprises at least three, preferably exactly three, polymer layer arrangements each with at least one polymer layer.

The present invention concerns additionally a method for manufacturing the aforementioned tube laminate, as will be described and developed hereunder. Method aspects arising from the description and advantageous development of the tube laminate are advantageous developments of the method according to the invention and vice versa.

### BACKGROUND OF THE INVENTION

Tube laminates for the manufacturing of tube container and/or of a roughly hose-shaped tube body, which is closed off at one end through a sealing seam, for a tube container, normally comprise several polymer layers in order to meet different technical requirements made on the tube container. The tube body of the tube container and consequently the tube laminate itself have to be sufficiently mechanically resilient in order to for instance withstand falling down off a shelf, have to remain elastic over a sufficiently long time in order to allow successive emptying of the tube container through repeated squeezing of the same, and in some circumstances have to provide barrier properties against migration of oxygen and/or water vapor and/or flavors through the container wall. Furthermore, often the tube body is formed through sealing of overlapping end regions of a laminate blank, such that sealability can also be desirable at the tube laminate, likewise printability of an exposed surface.

Normally, multilayer tube laminates are formed through bonding of prefabricated films. To this end, in the state of the art usually several separate films are bonded with one another through extrusion lamination and/or through adhesion lamination. In extrusion lamination, a thermally softened thermoplastic polymer is extruded between two prefabricated films in order to bond the two films with one another after setting through cooling. In adhesion lamination, a laminating adhesive is applied as a dispersion or solution between the films to be bonded in order to bond the two films with one another after setting through volatilization of a solvent or dispersant.

### SUMMARY OF THE INVENTION

It is the task of the present invention to propose a technical approach which makes it possible to manufacture high-quality tube laminates more cost-effectively and with greater flexibility.

According to a product aspect, the present invention solves this task through a tube laminate with at least three, preferably with exactly three, polymer layer arrangements each with at least one polymer layer, where exactly one polymer layer arrangement as a carrier structure is a prefabricated film, where a first side of the prefabricated film carries an outer polymer layer arrangement forming an outside of the tube laminate and where a second side of the prefabricated film which is opposite to the first side carries an inner polymer layer arrangement forming an inside of the tube laminate, where the outer and the inner polymer layer arrangement are polymer layer arrangements applied in the flowable state, where the tube laminate does not exhibit a further prefabricated film other than the carrier structure.

According to a method aspect, the present invention solves the task through a method for manufacturing a tube laminate as described above and developed hereunder, comprising the following steps:
Providing a polymer layer arrangement in the form of a prefabricated film as a carrier structure,
Applying an outer polymer layer arrangement in the flowable state on a first side of the carrier structure and thereby forming an exposed outside of the tube laminate, and
Applying an inner polymer layer arrangement in the flowable state on a second side of the carrier structure which is opposite to the first and thereby forming an exposed inside of the tube laminate.

The basic idea of the present invention is, therefore, that the tube laminate, starting from a single prefabricated film, is formed or will be formed as the case may be only through application of further layers in the flowable state, however not through lamination of a further film.

There suffices, therefore, the fabrication or the acquisition as the case may be of a single prefabricated film as a basic carrier structure of the tube laminate built up on it. All further layers of the tube laminate are applied in the flowable state, i.e. preferably through extrusion, where an additional or alternative application through applicator rollers should not be excluded. The polymer layers applied on both sides of the prefabricated film can be produced individually and modified as required. The tube laminate is consequently adaptable at little cost to changed constraints.

The application of several polymer layers of a polymer layer arrangement can take place in one work process through coextrusion of all polymer layers of the polymer layer arrangement or it can take place through several consecutive extrusion steps, of which at least one, assuming a sufficient number of polymer layers in the respective polymer layer arrangement, can in turn be a coextrusion step of two or more layers. Also, all polymer layers of the polymer layer arrangement can be extruded individually one after the other and one over the other.

There are known tube containers which are formed through blow molding of a multilayer blank. The present tube laminate differs from these tube containers by its essentially constant thickness across its length and width direction orthogonally to its thickness direction and likewise by the essentially constant thickness of the individual layers of the polymer layer arrangements of the tube laminate. If a polymer layer arrangement out of the inner and the outer polymer layer arrangement exhibits more than one polymer layer, these several polymer layers are arranged one over the other successively in the thickness direction of the carrier structure.

The tube laminate preferably exhibits a total thickness of between 110 μm and 350 μm, preferably 300 μm, including the region boundaries. With this total thickness, a sufficiently dense and mechanically resilient tube body can be created whose own weight remains sufficiently low compared with the filled weight of the tube container.

The prefabricated film as the carrier structure preferably exhibits a thickness of between 30 μm and 200 μm, including the region boundaries. Especially preferably, the carrier structure exhibits a thickness in the range from 50 μm to 140 μm. This makes possible the provision of a carrier structure sufficiently stable for accommodating further flowably applied layers. The carrier structure can be already provided with functional polymer layers, such as for instance at least one barrier layer for decreasing the transfer rates of oxygen and/or water vapor and/or flavors through the carrier structure and consequently through the tube laminate. The provision of functional polymer layers in the carrier structure facilitates the formation of the inner and outer polymer layer arrangement carried by the carrier structure, since these do not then any longer have to exhibit those functions and consequently functional layers, which are already realized in the carrier structure.

The prefabricated film is optionally a blown film or a cast film, i.e. a film manufactured in a casting process.

In principle, the prefabricated film can exhibit a single layer. For today's complex packaging applications, however, in order to realize desired functions it is advantageous if the prefabricated film is multilayer. Preferably the prefabricated film as the carrier structure is predominantly, i.e. to more than 50% by weight, made from a polyolefin, especially preferably from a polyethylene. But polypropylene should also not be excluded. In order to provide high barrier properties, in particular against migration of flavors from the packaged filling material through the tube laminate into the environment, the tube laminate can exhibit a layer made from a cyclic olefin copolymer (COC).

The prefabricated film can as a barrier layer arrangement exhibit metallization and/or a ceramic layer and/or a layer based on a vinyl alcohol and/or a polymer layer filled with at least partly ceramic particles. A vacuum-deposited aluminum layer is preferred as metallization. Silicone oxide (SiOₓ) or aluminum oxide (Al_{y}O_{z}) are possible for example as a ceramic layer. A barrier layer based on vinyl alcohol can be made from an ethylene-vinyl alcohol copolymer (EVOH), from a polyvinyl alcohol (PVOH), and/or from a butene diol-vinyl alcohol copolymer (BVOH). Ceramic particles as filling materials of a polymer layer are preferably metal nanoparticles, especially preferably in flake form, with a metal oxide skin enclosing the metal core. Due to the self-passivating properties of aluminum, aluminum nanoparticles with an aluminum oxide skin surrounding an aluminum core are preferred. Especially preferably, the aluminum core is flake-or plate-shaped, that is, exhibits in one spatial direction a considerably smaller dimension than in the two spatial directions orthogonal to this spatial direction and to one another.

If required, the prefabricated film can exhibit one or several bonding agent layers in order to bond with a bonding agent layer two adjacent layers. Thus for example, the prefabricated film can exhibit one or several layers made from a maleic anhydride-grafted polymer, from ethylene-acrylic acid copolymer (EAA), and the like.

One or several polymer layers of the prefabricated film can exhibit additives, such as for example a nucleating agent, in order to increase the degree of crystallization of the polymer of the respective layer. Likewise, one or several polymer layers can contain color pigments in order to give the prefabricated film a particular color. One or several polymer layers of the prefabricated film can be a foamed layer, for instance in order to provide particular visual effects or in order to decrease the weight per area of the polymer layer without changing the thickness.

The polymer layers of the carrier structure can be present unstretched, can be stretched monoaxially in a single direction, or can be stretched biaxially for increasing the strength in comparison with an unstretched identically constructed film of the same thickness. Due to the described manner of manufacturing, the prefabricated film is the only polymer layer arrangement of the tube laminate, which optionally exhibits a molecular orientation due to stretching.

The inner and the outer polymer layer arrangement preferably each exhibit a thickness in the range between 15 μm and 130 μm, including the region boundaries.

The inner and/or the outer polymer layer arrangement can be single-layer. Preferably, at least one polymer layer arrangement out of the inner and the outer polymer layer arrangement is multilayer, especially preferably both are multilayer.

In principle, the inner and the outer polymer layer arrangement can be arranged mirror-symmetrically with respect to the carrier structure. The mirror symmetry is a mirror symmetry with regard to the materials of the layer sequence on both sides of the carrier structure in the direction away from the carrier structure and/or is a mirror symmetry with regard to the thickness of the layers of the layer sequence on both sides of the carrier structure in the direction away from the carrier structure.

The manufacturing process to form the tube laminate being discussed here, however, allows advantageously an individual configuration of each single layer on both sides of the carrier structure. For tube laminates, a symmetrical configuration is important neither with regard to the sequence of materials nor with regard to the sequence of thickness dimensions. Preferably, therefore, the tube laminate is asymmetrical with respect to the carrier structure with regard to sequence of materials and/or with regard to a sequence of thickness dimensions of the individual layers on both sides of the carrier structure.

At least one polymer layer arrangement out of the inner and the outer polymer layer arrangement provides an exposed sealable surface. This is normally the inner polymer layer arrangement. However, when a longitudinal sealing seam proceeding along a tube longitudinal axis of a tube body formed from the tube laminate is to be realized through sealing of overlapping end regions of a tube laminate blank formed from the tube laminate, the configuration of an exposed sealable surface is also advantageous at the outer polymer layer arrangement. Namely, in this case the sealing is ‘inside against outside’. Additionally or alternatively, preferably the outer polymer layer arrangement provides an exposed printable surface. To this end, it is advantageous if the outer polymer layer arrangement provides at least one polymer layer with color pigments, in particular with white color pigments, as a neutral substrate in order to be able to show to advantage printing inks applied outside onto the outer polymer layer arrangement especially well and authentically.

Preferably, the two external layers of the inner and the outer polymer layer arrangement, each of which forms an exposed surface of the tube laminate, are manufactured from the same material. Their good sealability with one another is thereby ensured.

Since the outer polymer layer arrangement thus normally solves a more extensive functional task assignment than the inner polymer layer arrangement, the outer polymer layer arrangement preferably exhibits the same thickness as or exhibits greater thickness than the inner polymer layer arrangement.

The preferred application of the outer and the inner polymer layer arrangement through extrusion coating can then realized with especially high quality and reliably, if the inner and the outer polymer layer arrangement each exhibits a polymer with a melt flow index in the range between 3.0 g/10 min and 8.0 g/10 min, especially preferably between 4.0 g/10 min and 6.0 g/10 min, in each case including the region boundaries, measured in accordance with DIN EN ISO 1133 at a test temperature of 190° C. and with a test load of 2.16 kg. When the outer and/or the inner polymer layer arrangement is to be multilayer, which will be the normal case, for the same reason it is advantageous if a predominant weight fraction of at least one multilayer polymer layer arrangement, especially preferably if the whole multilayer polymer layer arrangement, even more preferably if both multilayer polymer layer arrangements, is or are as the case may be made completely from one or several polymers with a melt flow index in the aforementioned range.

For facilitated application of the outer and the inner polymer layer arrangement in the flowable state onto a stable prefabricated film, the melt flow index of each polymer layer arrangement out of the outer and the inner polymer layer arrangement is preferably greater than the melt flow index of the prefabricated film, measured in accordance with the aforementioned measurement conditions. Especially preferably, the melt flow index of each polymer layer arrangement out of the outer and the inner polymer layer arrangement is greater by at least 2.0 g/10 min, more preferably by at least 2.5 g/10 min, even more preferably by at least 3.0 g/10 min, than the melt flow index of the prefabricated film.

A stable prefabricated film especially well suited for applying the outer and the inner polymer layer arrangement in its flowable state through extrusion coating is preferably made from a polymer with a melt flow index in the range between 0.5 g/10 min and 1.8 g/10 min, preferably between 0.7 g/10 min and 1.1 g/10 min, in each case including the region boundaries, measured in accordance with DIN EN ISO 1133 at a test temperature of 190° C. and with a test load of 2.16 kg. When the prefabricated film should be multilayer, for the same reason it is advantageous if a predominant weight fraction of the polymer layers, especially preferably if the multilayer prefabricated film in its entirety, even more preferably if each individual polymer layer of the multilayer prefabricated film, is or are as the case may be made completely from one or several polymers with a melt flow index in the aforementioned range.

In principle, the inner polymer layer arrangement and/or the outer polymer layer arrangement can be made from thermoplastic polymers. Preferably, a polyolefin such as polyethylene (PE) or polypropylene (PP), especially preferably PE, is used to form the inner polymer layer arrangement and/or the outer polymer layer arrangement. PVOH, BVOH, EVOH, and COC are additional possibilities as materials for layers for the inner polymer layer arrangement and/or the outer polymer layer arrangement. If biodegradability of individual or all layers of a polymer layer arrangement is desired, polylactic acid (PLA) can be used as a thermoplastic polymer. Likewise, the inner polymer layer arrangement and/or the outer polymer layer arrangement can comprise maleic anhydride-grafted polymers, ethylene-acrylic acid copolymer (EAA), and/or ethylene methyl acrylate (EMA). Finally, at least one polymer layer of the inner polymer layer arrangement and/or of the outer polymer layer arrangement can exhibit additives such as nucleating agents for increasing the crystallinity of a layer or at least partly ceramic particles for decreasing the oxygen and/or water vapor transfer rate. If both nucleating agents and at least partly ceramic particles are added, these are further preferably included in different layers.

For reasons of facilitated recycling of the tube laminate, it is preferable that at least one polymer layer arrangement out of the inner and the outer polymer layer arrangement, especially preferably both polymer layer arrangements, is made predominantly or to at least 90% by weight from one or several polymers based on the same monomer. Preferably this monomer is ethylene and the polymer made from it polyethylene. The polymer polyethylene can, however, be present in different types such as LLDPE, LDPE, MDPE, and HDPE or in blends thereof.

The carrier structure too, for reasons of facilitated recycling is made, preferably to at least 90% by weight, from one or several polymers based on the same monomer. In order to promote recyclability not only of individual polymer layer arrangements but of the whole tube laminate, the base monomer of the polymers of the carrier structure is preferably the base monomer of the polymers of the inner and the outer polymer layer arrangement, that is, especially preferably ethylene.

If required, in order to increase the strength of the bonding of the carrier structure with one or with both aforementioned polymer layer arrangements, a primer layer can be applied between the carrier structure and at least one polymer layer arrangement out of the inner and the outer polymer layer arrangement. The primer layer, which when dry preferably exhibits a thickness in the range from 0.5 g/m² to 5 g/m², is preferably applied as a water-based coating, for instance by roller application. The primer layer can exhibit PVOH, BVOH, acrylic-modified polyethylene, a polyolefin-resin emulsion, polyethyleneimine (PEI), polyurethane, EAA, and EAA/ionomer dispersions or be made from such materials.

Normally the primer layer, if required, is applied directly on a free surface of the carrier structure and then dried. After the drying of the primer layer, there then takes place the application of the respective polymer layer arrangement on the surface of the dried primer layer.

To ensure the best possible compatibility of the tube laminate with a sensitive filling material, the primer layer is preferably made from a water-based dispersion.

In order to protect the filling material which is packaged with the involvement of the tube laminate, the tube laminate preferably exhibits an oxygen transmission rate of no more than 2.0 cm³/(m²·d·bar), preferably of no more than 1.5 cm³/(m²·d·bar), measured in accordance with DIN 53380-3 under the test conditions of 23° C. temperature and 75% relative humidity.

Additionally or alternatively, in order to protect the filling material which is packaged with the involvement of the tube laminate, the tube laminate preferably exhibits a water vapor transmission rate of no more than 1.5 g/(m²·d), preferably of no more than 1.0 g/(m²·d), measured in accordance with DIN EN ISO 15106-3 under the test conditions of 23° C. temperature and 85% relative humidity.

The invention also comprises a tube container extending along a tube longitudinal axis which defines an axial direction, comprising a tube body and a tube shoulder, where the tube shoulder comprises a removal aperture for removal from the tube body of filling material packaged in the tube container, where the tube body is formed from a tube laminate as described and developed above, where at its axial longitudinal end lying nearer to the tube shoulder the tube body encircling the tube longitudinal axis in a closed manner is bonded with the tube shoulder and where at its axial longitudinal end lying remotely from the tube shoulder the tube body is closed off through a sealing seam.

The process for manufacturing the tube laminate described and developed above can comprise a tandem application of the inner and the outer polymer layer arrangement. Likewise, the process can comprise a deflection of the running material web after application of a polymer layer arrangement out of the inner and the outer polymer layer arrangement for subsequent application of the still missing respective other polymer layer arrangement. The deflection can take place through a deflecting roller or through a deflecting rod.

These and other objects, aspects, features and advantages of the invention will become apparent to those skilled in the art upon a reading of the Detailed Description of the invention set forth below taken together with the drawings which will be described in the next section.

### BRIEF DESCRIPTION OF THE DRAWINGS

The invention may take physical form in certain parts and arrangement of parts, a preferred embodiment of which will be described in detail and illustrated in the accompanying drawings which forms a part hereof and wherein:

FIG. 1A rough schematic cross-section through an embodiment of a tube laminate according to the invention, and

FIG. 2A rough schematic view of a tube container formed with the involvement of the tube laminate of FIG. 1.

The drawings are not to scale.

### DESCRIPTION OF PREFERRED EMBODIMENTS

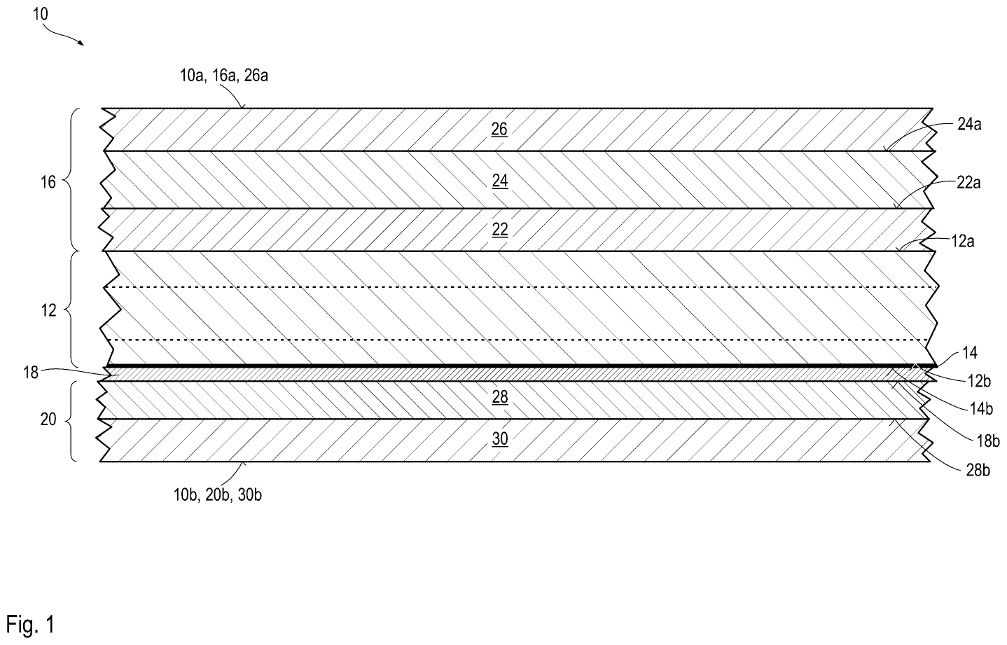

Referring now to the drawings wherein the showings are for the purpose of illustrating preferred and alternative embodiments of the invention only and not for the purpose of limiting the same, in FIG. 1 in a rough schematic cross-sectional view an embodiment according to the invention of a multilayer tube laminate 10 is depicted. The tube laminate 10 exhibits on a tube container manufactured with its involvement an outside 10a facing towards the consumer and an inside 10b facing towards the packaged product. For better orientation, all layer sides mentioned hereunder which face towards the consumer are labelled with a lowercase “a” and all layer sides facing towards the product with a lowercase “b”.

A central carrier structure of the tube laminate 10 is formed through a prefabricated film 12, which in the depicted example is a triple-layer blown film made from polyethylene, which on its inside 12b carries a vacuum-deposited metallization 14 made from aluminum.

In film 12, the individual polyethylene layers which can be formed from polyethylene types of different densities are indicated by dotted lines.

The prefabricated film 12 exhibits in the depicted example a thickness of 60 μm. The thickness of the vapor-deposited metallization 14 plays no noteworthy part compared with the thickness of the film.

The prefabricated film 12 is only shown as an example. Instead of the triple-layer polyethylene film 12, a 7-layer prefabricated film could for example be used, which instead of metallization exhibits a polyvinyl alcohol-based barrier layer, for example an EVOH layer. Such a 7-layer prefabricated film can exhibit a preferred thickness of between 90 μm and 130 μm. Such a 7-layer prefabricated film too, will preferably exhibit, besides the aforementioned EVOH layer and any bonding agent layers which may be required, on both sides of the EVOH layer preferably only polyethylene layers in order to ensure the highest possible content of polymers in the prefabricated film which are based on one and the same monomer, in the present case ethylene. This facilitates the recycling of the prefabricated film and of the tube laminate 10 overall.

On the outside 12a of the prefabricated film 12 there is applied directly an outer polymer layer arrangement 16. On the inside 12b of the prefabricated film 12 facing away from the outside 12a or inside 14b of the vapor-deposited metallization 14 as the case may be, the film 12 carries with the interposition of a primer layer 18 an inner polymer layer arrangement 20. The primer layer 18 is required in the present embodiment example as a bonding agent towards the metallization 14.

The outer polymer layer arrangement 16 and the inner polymer layer arrangement 20 are each applied completely through extrusion coating in the flowable state. The application can take place coating-wise individually or as coextrusion under concurrent extrusion of at least two immediately adjacent coatings.

The primer layer 18 with a preferred thickness of 1 μm was applied in roller application as an aqueous dispersion onto the metallization 14 and then dried. After the drying, the extrusion coating of the inner polymer layer arrangement 20 can then take place onto the dried outside 18b of the primer layer 18.

Onto the outside 12a of the prefabricated film 12, which to begin with presents an exposed polyethylene surface, there is extruded in the depicted embodiment example a first outer layer 22 made from polyethylene with a thickness of 25 to 35 μm. In the present case, the first outer polyethylene layer 22 is a layer made from a blend of HDPE and MDPE. Since the outside 10a of the tube laminate, which is also the outside 16a of the first polymer layer arrangement 16, is envisaged for printing with printing inks, the first outer polyethylene layer 22 can comprise white color pigments, for example titanium oxide, in order to provide a sufficiently opaque substrate for later printing ink application. The white color pigments are preferably introduced by admixing a master batch into the HDPE-MDPE blend of the first outer polyethylene layer 22.

Onto the outside 22a of the first outer polyethylene layer 22 there is extruded a second outer polyethylene layer 24, either through coextrusion with the first outer polyethylene layer 22 or through subsequent separate extruding. In the present embodiment example, the second outer polyethylene layer 24 exhibits a thickness in the range from 30 to 45 μm and is likewise formed through a blend of HDPE and MDPE. The mixing ratio of HDPE and MDPE in the blend of the second outer polyethylene layer 24 can be the same as in the blend of the first outer polyethylene layer 22 or can differ from it. The second outer polyethylene layer 24 too, exhibits white color pigments in order to provide an opaque neutral substrate for later printing ink application. In the case of the second outer polyethylene layer 24 too, these are preferably admixed as a master batch. When only one layer of the outer polymer layer arrangement 16 is to be filled with color pigments, in particular with white color pigments, preferably this is the second outer polyethylene layer 24.

Onto the outside 24a of the second outer polyethylene layer 24 there is extruded a third outer polyethylene layer 26, once again either as an extruded single layer or in coextrusion with the second outer polyethylene layer 24.

The outside 26a of the third outer polyethylene layer 26, which is also the outside 16a of the outer polymer layer arrangement 16 and the outside 10a of the tube laminate 10, is designed for receiving printing inks through subsequent printing. Moreover, it should be sealable with the inside 20b of the inner polymer layer arrangement 20 forming the inside 10b of the tube laminate 10. The third outer polyethylene layer 26 exhibits in order to improve its sealability a blend of MDPE and LDPE or of MDPE and LLDPE. In the present case, a blend of MDPE and LDPE is preferred. The third outer polyethylene layer 26 exhibits a thickness in the range from 20 to 40 μm.

Onto the dried primer 18 there is extruded a first inner polyethylene layer 28 of the inner polymer layer arrangement 20. Like the first outer polyethylene layer 22, this first inner polyethylene layer 28 can be made from a blend of HDPE and MDPE. In the specific embodiment example, the first inner polyethylene layer 28 is made from LDPE. The first inner polyethylene layer 28 can exhibit a thickness from 20 to 40 μm. In the depicted embodiment example it exhibits a thickness of 30 μm.

Onto the outside 28a of the first inner polyethylene layer 28 there is extruded a second inner polyethylene layer 30, which is sealable. The extrusion of the second inner polyethylene layer 30 can take place as coextrusion with the first inner polyethylene layer 28 or as separate extrusion of a single layer.

In order to ensure the highest possible sealing quality for sealing with the third outer polyethylene layer 26, the second inner polyethylene layer 30 is made from the same blend as the third outer polyethylene layer 26, thus in the present case from a blend of MDPE and LDPE, where here too LLDPE could be used instead of LDPE.

The second inner polyethylene layer 30 too, exhibits in the depicted embodiment example the same thickness as the third outer polyethylene layer 26, thus 40 μm although this does not have to be the case. The second inner polyethylene layer 30 can exhibit a thickness in the range from 25 to 45 μm, preferably in the range from 30 to 40 μm.

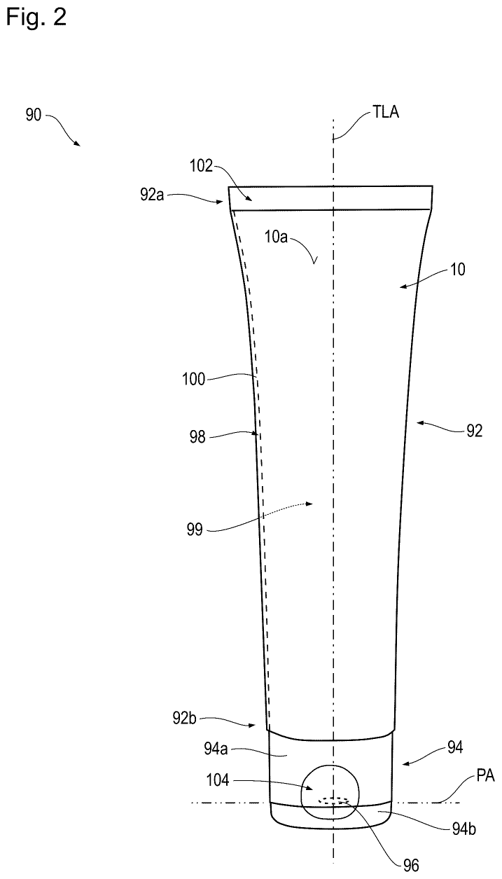

The second inner polyethylene layer 30 is sealed not only for forming the tube body 92 elucidated hereunder with the third outer polyethylene layer 26, but also with the outside of a tube shoulder 94a of a tube top 94 as shown in FIG. 2.

FIG. 2 shows a schematic front view of a tube container 90, which exhibits a tube body 92 from the multilayer tube laminate 10 and a tube top 94. The tube top 94 comprises a tube shoulder 94a and a cap 94b on which the tube container 90 can stand bonded integrally with the tube shoulder in a pivotable manner.

To form the tube body 92, a blank cut of the multilayer tube laminate 10 is wound around a mandrel such that the encircling end regions of the wound-around blank cut overlap. In the overlap region 98 thus created, the exposed innermost polymer surface 10b overlaps the exposed outermost polymer surface 10a axially along a tube longitudinal axis TLA and in the circumferential direction around the tube longitudinal axis TLA. The two exposed polymer surfaces 10a and 10b and the polyethylene layers 26 and 30 forming them are bonded in the overlap region 98 through hot sealing, such that a longitudinal bonding seam 100 is created as a lap seal in an overlapping configuration.

At the closed longitudinal end 92a facing away from the tube top 94, the tube body 92 is closed off through a fin sealing seam 102. Unlike the longitudinal bonding seam 100, where the exposed inner surface 10b is sealed with the exposed outer surface 10a, in the transverse seam 102 opposite regions of the inner surface 10b are sealed with one another.

The tube body 92 encloses at the open longitudinal end 92b near the tube top 94 a part of the tube shoulder 94a of the tube top 94 and overlaps it completely in the axial direction and in the circumferential direction. The overlapping parts of the tube body 92 and of the tube shoulder 94a are likewise bonded through heat sealing. For this purpose, the tube top 94 is formed from injection-molded polyethylene, such that the materials of the tube top 94 and of the polyethylene layer 30 of the multilayer tube laminate 10 are compatible with one another. In a packaging space 99 enclosed by the tube container 90 there can be accommodated e.g. a paste-like product, which can be released through a tube aperture 96.

The cap 94b is pivotable about a pivot axis PA, for example through a film joint which connects the cap 94b integrally with the tube shoulder 94a in order to cover the tube aperture 96. A depression 104 facilitates the lifting of the cap 94a off the tube shoulder 94a for opening the tube container 90.

While considerable emphasis has been placed on the preferred embodiments of the invention illustrated and described herein, it will be appreciated that other embodiments, and equivalences thereof, can be made and that many changes can be made in the preferred embodiments without departing from the principles of the invention. Furthermore, the embodiments described above can be combined to form yet other embodiments of the invention of this application. Accordingly, it is to be distinctly understood that the foregoing descriptive matter is to be interpreted merely as illustrative of the invention and not as a limitation.

1-15. (canceled)

16. A tube laminate comprising at least three polymer layer arrangements each with at least one polymer layer, where exactly one polymer layer arrangement as a carrier structure is a prefabricated film, where a first side of the prefabricated film carries an outer polymer layer arrangement forming an outside of the tube laminate and where a second side of the prefabricated film which is opposite to the first side carries an inner polymer layer arrangement forming an inside of the tube laminate, where the outer and the inner polymer layer arrangement are polymer layer arrangements applied in the flowable state, where the tube laminate does not exhibit a further prefabricated film other than the carrier structure.

17. The tube laminate according to claim 16, wherein the tube laminate exhibits a total thickness of between 110 μm and 350 μm, including the region boundaries.

18. The tube laminate according to claim 17, wherein the carrier structure exhibits a thickness of between 30 μm and 200 μm, including the region boundaries.

19. The tube laminate according to claim 16, wherein the carrier structure exhibits a thickness of between 30 μm and 200 μm, including the region boundaries.

20. The tube laminate according to claim 16, wherein the prefabricated film is a blown film or a cast film.

21. The tube laminate according to claim 16, wherein the prefabricated film is multilayer.

22. The tube laminate according to claim 16, wherein the prefabricated film as a barrier layer arrangement exhibits a metallization and/or a ceramic layer and/or a layer based on a vinyl alcohol and/or a polymer layer filled with at least partly ceramic particles.

23. The tube laminate according to claim 16, wherein the inner and the outer polymer layer arrangement each exhibit a thickness in the range of between 15 μm and 130 μm, including the region boundaries.

24. The tube laminate according to claim 16, wherein the outer polymer layer arrangement exhibits the same thickness as or a greater thickness than the inner polymer layer arrangement.

25. The tube laminate according to claim 16, wherein the inner and the outer polymer layer arrangement each exhibits a polymer with a melt flow index in the range between 3.0 g/10 min to 8.0 g/10 min, including the region boundaries, measured in accordance with DIN EN ISO 1133 at a test temperature of 190° C. and with a test load of 2.16 kg, or are completely made from one or several polymers with a melt flow index in this range.

26. The tube laminate according to claim 25, wherein the melt flow index of the inner and the outer polymer layer arrangement is each greater than the melt flow index of the prefabricated film, measured in accordance with DIN EN ISO 1133 at a test temperature of 190° C. and with a test load of 2.16 kg.

27. The tube laminate according to claim 16, wherein at least one polymer layer arrangement out of the inner and the outer polymer layer arrangement is made predominantly or at least to 90% by weight from one or several polymers based on the same monomer.

28. The tube laminate according to claim 16, wherein between the carrier structure and at least one polymer layer arrangement out of the inner and the outer polymer layer arrangement there is applied a primer layer.

29. The tube laminate according to claim 28, wherein the primer layer is made from a water-based dispersion.

30. The tube laminate according to claim 16, wherein at least one polymer layer arrangement out of the inner and the outer polymer layer arrangement provides an exposed sealable surface and/or that the outer polymer layer arrangement provides an exposed printable surface.

31. A tube container extending along a tube longitudinal axis which defines an axial direction, comprising a tube body and a tube shoulder, where the tube shoulder comprises a removal aperture for removal from the tube body of filling material packaged in the tube container, where the tube body is formed from a tube laminate according to claim 16, where the tube body encircling the tube longitudinal axis in a closed manner is bonded at its axial longitudinal end lying nearer to the tube shoulder with the tube shoulder and where the tube body at its axial longitudinal end lying remotely from the tube shoulder is closed off through a sealing seam.

32. A method for manufacturing a tube laminate according to claim 16, comprising the following steps:
providing a polymer layer arrangement in the form of a prefabricated film as a carrier structure,
applying an outer polymer layer arrangement in the flowable state on a first side of the carrier structure and thereby forming an exposed outside of the tube laminate, and
applying an inner polymer layer arrangement in the flowable state on a second side of the carrier structure which is opposite to the first and thereby forming an exposed inside of the tube laminate.
